(19) United States
(12) Patent Application Publication
(10) Pub. No.: US 2024/0365124 A1
(43) Pub. Date: Oct. 31, 2024

(54) Method for connecting a first station to a second station in a wireless communication network, and corresponding first and second stations and corresponding computer program

(71) Applicant: ORANGE, Issy-les-Moulineaux (FR)

(72) Inventors: Elyass Najmi, CHÂTILLON CEDEX (FR); Hélène Ralle, CHÂTILLON CEDEX (FR)

(21) Appl. No.: 18/579,605

(22) PCT Filed: Jul. 13, 2022
(86) PCT No.: PCT/FR2022/051413

§ 371 Date: Jan. 16, 2024

(30) Foreign Application Priority Data
Jul. 16, 2021 (FR) FR2107683

(51) Int. Cl. H04W 12/50; H04L 9/40; H04W 12/73

(52) U.S. Cl. CPC H04W 12/50; H04L 63/105; H04W 12/73

(57) ABSTRACT

A method for connecting a first station to a second station in a wireless communication network. The method includes the second station implementing: transmitting, to the first station, at least one item of information representative of a security mode supported by the second station; and connecting to a basic service set to which the first station belongs, selected by the first station based on the at least one item of information representative of a security mode supported by the second station.

### 1. FIELD OF THE INVENTION

The field of the invention is that of telecommunications.

More specifically, the invention relates to securing the access to a wireless network, for example of the Wireless Local Access Network (WLAN) type.

### 2. PRIOR ART

A WLAN network uses in particular the wireless transmission technology based on the IEEE 802.11 radio network standard and its evolutions, commonly grouped as Wi-Fi (Wireless Fidelity). Such a network is commonly called a Wi-Fi network.

Typically, a Wi-Fi network in infrastructure mode comprises at least two stations, one being an access point/router (AP) and one being a client terminal. To be able to connect to the access point, for example a Livebox (registered trademark), the client terminal must have three parameters: the name of the Wi-Fi network (SSID for Service Set Identifier), a Wi-Fi key, and a security mode compatible with the security mode configured at the access point level.

It is noted that if these three parameters are validated and memorised by the client terminal, it can connect to the Wi-Fi network. If one of these three parameters changes, the configuration is no longer valid and the connection may be refused.

The security mode enables in particular to protect the data exchanged between the client terminal and the access point. For example, the security mode defined by the Wi-Fi Alliance organisation is of the WPA (Wi-Fi Protected Access) type, in particular WPA2 or WPA3.

In the frequency bands around 2.4 GHz or 5 GHZ, traditionally used for transmitting signals in a Wi-Fi network, the security mode that is mainly used is of the WPA2 type.

In the 6 GHz frequency band, soon to be used for transmitting signals in a Wi-Fi network, the recommended security mode is of the WPA3 type.

A client terminal that supports WPA2 security mode (or an earlier version) can connect to an access point that supports both WPA2 and WPA3 security modes. However, a client terminal that supports WPA2 security mode (or an earlier version) cannot connect to an access point that only supports WPA3 security mode.

A new security mode, noted WPA3-TM (“Transition Mode”), has therefore been defined by the Wi-Fi Alliance organisation, to be used in environments where terminals supporting WPA2 security mode and terminals supporting WPA3 security mode coexist.

Thus, when the network or the access point has to manage several security modes, the security mode to be privileged at the access point level is the WPA3-TM security mode.

One disadvantage of using this WPA3-TM security mode is that there are, for some terminals (for example of the smartphone, printer, connected TV, etc. type) interoperability problems with access points that activate the WPA3-TM security mode.

There is therefore a need for a new technique for securing access to a wireless network.

### 3. SUMMARY OF THE INVENTION

The invention proposes a solution that does not have all the disadvantages of the prior art, in the form of a connection method between a first station and a second station in a wireless communication network.

According to the invention, the second station implements:
the transmission, to said first station, of at least one item of information representative of a security mode supported by said second station,
the connection to a basic service set to which said first station belongs, selected by said first station based on said at least one item of information representative of a security mode supported by said second station.

Thus, according to the invention, the second station, for example a client terminal, can inform the first station, for example an access point, of the security mode(s) it supports. Upon reception of this item of information, the first station can choose the security mode adapted for the connection of the first station to the second station, the second station connecting to the basic service set configured with this security mode.

For this purpose, it is recalled that a basic service set (BSS) is a set formed by an access point and the terminals associated with this access point, according to a particular configuration (including for example the name of the Wi-Fi network and a security mode).

Thus, the association of the second station is only implemented with a BSS that is “compatible” with the security mode(s) supported by the second station, which allows to avoid interoperability problems. In particular, the second station is associated with the BSS that has the highest level of security among the security modes supported by the second station.

For example, the security modes belong to the group comprising:
WPA2 security mode;
WPA3 security mode;
other current or future security modes, such as WPA4 security mode.

Said at least one item of information representative of a security mode supported by said second station may in particular list exhaustively all the security modes supported by the second station.

As a variant, said at least one item of information representative of a security mode supported by said second station corresponds to the number of security modes supported by said second station.

For example, if only one security mode is supported by the second station, the first station will deduce that the security mode supported by the second station is WPA2. If two security modes are supported by the second station, the first station will deduce that the security modes supported by the second station are WPA2 and WPA3. If three security modes are supported by the second station, the first station will deduce that the security modes supported by the second station are WPA2, WPA3 and WPA4, etc.

According to a particular embodiment, the second station further implements the reception of an identifier of at least one first basic service set to which said first station belongs, said at least one first basic service set being configured with a first security mode, and said connection comprises the reception of a routing request to said selected basic service set, if the selected basic service set, referred to as second basic service set, is configured with a second security mode supported by said second station and having a higher level of security than said first level of security.

According to this embodiment, the second station receives an identifier from at least one first basic service set. For example, the first basic service set is configured with the lowest level of security (for example WPA2) and is therefore supported by all the stations.

If the first station, upon reception of the item of information representative of a security mode supported by the second station, determines that the second station supports a second security mode, offering better protection than the first security mode configured for the first basic service set, the proposed solution enables to automatically route the second station to the second basic service set configured with this second security mode (supported by the second station).

This second basic service set is preferably not visible to the user of the second station, i.e. only one identifier of said at least one first basic service set is displayed on an interface (for example a screen) of the second station. In this way, the user of the second station only sees one identifier from a first BSS, and the first station can take care, if necessary, of routing the second station to a second BSS that is not broadcast, but is more adapted (for example because it is configured with a higher level of security).

By displaying only one BSS, the risk of the user of the second station choosing a “wrong BSS” (i.e. one having a low-security mode, or one that is not supported by the second station) is avoided, which would lead to a degradation of the customer experience with the reception of inconsistent and varied error messages.

The proposed solution allows to automatically route the second station to the BSS selected by the first station, taking into account the item of information representative of a security mode supported by the second station. This operation is therefore transparent to a user of the second station. In particular, if the second station is a multi-band terminal, capable of transmitting or receiving signals on several frequency bands in a Wi-Fi network (for example a frequency band around 6 GHz when it is close to the access point, or a frequency band around 2.4 GHz when it moves away from the access point), the change of security mode inherent in the change of frequency band can thus be carried out quickly and transparently for the user, i.e. without interfering with the user experience.

For example, the first station can be considered to belong to:
two “first basic service sets”: a first BSS, noted BSS1, in a 2.4 GHz frequency band, and a second BSS, noted BSS2, in a 5 GHz frequency band, having the same configuration, for example a Wi-Fi network name “SSID1” and a WPA2 security mode;
a “second basic service set”: a third BSS, noted BSS3, in a 6 GHz frequency band, having a different configuration, for example a Wi-Fi network name “SSID2” and a WPA3 security mode. BSS1 and BSS2, each associated with a separate frequency band, form an extended service set (ESS) having a common service set identifier SSID. At the logical link control (LLC) layer, the ESS appears as a single BSS for each station.

According to a particular embodiment, said connection further comprises the transmission, to said first station, of a response to said routing request authorising the routing to said second basic service set and the connection of said second station to said second basic service set.

Thus, upon reception of a routing request, the second station can choose whether or not to associate with the BSS identified in the routing request, and inform the first station about it.

The invention also relates to a method for connecting a first station to a second station in a corresponding wireless communication network, implemented by the first station.

According to the invention, the first station implements:
the reception, from said second station, of at least one item of information representative of a security mode supported by said second station,
the selection of a basic service set to which said first station belongs, based on said at least one item of information representative of a security mode supported by said second station.

As indicated above, the first station can thus verify whether the security mode(s) supported by the second station are compatible with at least one security mode of a BSS to which the first station belongs, so that the second station associates with a BSS compatible with a security mode that the second station supports, preferably the BSS having the highest level of protection.

According to a particular embodiment, such a method also comprises, implemented by the first station:
the transmission of an identifier of at least one first basic service set to which said first station belongs, said at least one first basic service set being configured with a first security mode,
the transmission of a routing request to said selected basic service set, if the selected basic service set, referred to as the second basic service set, is configured with a second security mode supported by said second station and having a higher level of security than said first level of security.

Thus, as indicated previously, the proposed solution allows to automatically route the second station to a BSS selected by the first station, taking into account the item of information representative of a security mode supported by the second station.

As the second security mode offers better protection than the first security mode, the second station can choose to associate with the first BSS, or to be routed to the second BSS if it supports the first and second security modes.

In particular, the first station implements the reception, from said second station, of a response to said routing request authorising the routing to said second basic service set and the connection of said second station to said second basic service set.

Thus, as indicated above, upon reception of a routing request, the second station can choose whether or not to associate with the BSS identified in the routing request, and inform the first station accordingly.

According to a particular embodiment, said at least one item of information representative of a security mode supported by said second station is transmitted in a field of the “Robust Security Network Information Element” type.

Such a field is described in particular in paragraph 9.4.2.24 of the IEEE 802.11-2020 standard.

In particular, said at least one item of information representative of a security mode supported by said second station is transmitted in a message of the “Probe Request” type.

Such a message is typically transmitted from the second station to the first station, so that the second station can associate with a BSS to which the first station belongs. Thus, the proposed solution does not require sending any additional message.

In particular, said at least one item of information representative of a security mode supported by said second station can be transmitted in a field of the “Robust Security Network Information Element” type inserted in a message of the “Probe Request” type.

The invention further relates to a corresponding first station of a wireless communication network, comprising:
means for receiving, from a second station of said network, at least one item of information representative of a security mode supported by said second station,
means for selecting a basic service set to which said first station belongs, based on said at least one item of information representative of a security mode supported by said second station.

In infrastructure mode, such a first station is for example an access point (gateway, set top box, etc.).

In ad-hoc mode, such a first station is for example a client terminal (smartphone, tablet, printer, connected TV, etc.).

The invention relates moreover to a corresponding second station of a wireless communication network, comprising:
means for transmitting, to a first station of said network, at least one item of information representative of a security mode supported by said second station,
means for connecting to a basic service set to which said first station belongs, selected by said first station based on said at least one item of information representative of a security mode supported by said second station.

Such a second station is for example a client terminal (smartphone, tablet, printer, connected TV, etc.).

The invention also relates to one or more computer programs comprising instructions for implementing a connection method as described above when this or these programs are executed by at least one processor.

The invention finally relates to one or more computer-readable storage media, on which are saved one or more computer programs comprising program code instructions for implementing at least one step of a connection method as described above, according to any one of the embodiments. Such storage media can be any entity or device able to store a program.

### 4. LIST OF FIGURES

Other characteristics and advantages of the invention will emerge more clearly upon reading the following description of a particular embodiment, provided as a simple illustrative non-restrictive example, and the annexed drawings, wherein:

FIG. 1 illustrates an example of a Wi-Fi communication network comprising a first station STA1 and a second station STA2;

FIG. 2 shows the main steps implemented by the first and second stations STA1 and STA2 according to a particular embodiment of the invention;

FIG. 3 illustrates an example of an exchange of messages for connecting the first and second stations STA1 and STA2 according to a particular embodiment;

FIG. 4 shows the simplified structure of a first station according to a particular embodiment;

FIG. 5 shows the simplified structure of a second station according to a particular embodiment.

### 5. DESCRIPTION OF A PARTICULAR EMBODIMENT

### 5.1 General Principle

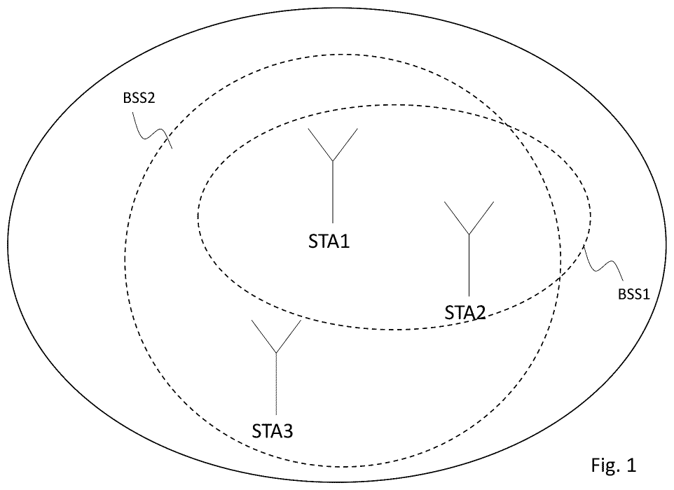

The context is that of a Wi-Fi communication network implementing at least two stations STA1 and STA2, as illustrated in FIG. 1. Such a Wi-Fi network can operate in infrastructure or ad-hoc mode.

The general principle of the invention is based on informing, at the first station level, the security mode(s) supported by the second station. In this way, the first station can select a basic service set to which it belongs, configured with a security mode supported by the second station, so that the second station can associate with a “right” basic service set. In particular, the first station selects the basic service set configured with the security mode supported by the second station offering the highest level of security.

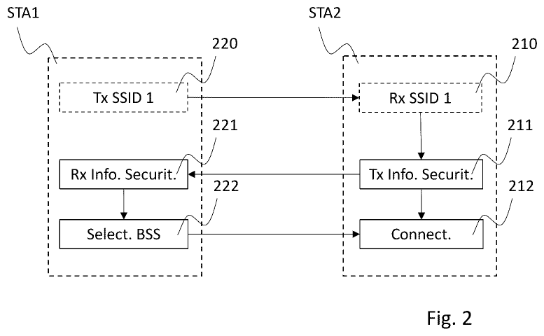

In relation to FIG. 2, the main steps implemented by the first station STA1 and the second station STA2 according to an embodiment of the invention are presented hereinafter.

During a step 211, the second station STA2 transmits, to the first station STA1, at least one item of information representative of a security mode supported by the second station STA2. For example, such an item of information comprises a list of the security mode(s) supported by the second station STA2, a number of security modes supported by the second station STA2, etc.

The first station STA1 thus receives, during a step 221, said at least one item of information representative of a security mode supported by the second station STA2.

Upon reception of this item of information, the first station STA1 can select, during a step 222, a basic service set to which the first station STA1 belongs, based on said at least one item of information representative of a security mode supported by the second station STA2.

For example, if the second station STA2 supports only one security mode, the first station STA1 selects the basic service set configured with that security mode. The first station STA1 can optionally inform the second station STA2 of the selected basic service set, but this step is optional in this case.

If the second station STA2 supports several security modes, the first station STA1 selects, for example, the basic service set configured with the security mode having the highest level of security. In this case, the first station STA1 informs the second station STA2 of the selected basic service set.

The second station STA2 can thus connect, during a step 212, to the basic service set selected by the first station STA1, without going through a connection to another basic service set which would offer a lower level of security for example.

According to a particular embodiment, the first station STA1 broadcasts beforehand in the Wi-Fi network, during a step 220, an identifier of at least a first basic service set to which it belongs, configured with a first security mode. The second station STA2, in particular, receives this identifier during a step 210. For example, this first security mode has the lowest level of security (for example WPA2) and can therefore be supported by all the stations of the Wi-Fi network.

If the second station STA2 supports only the first security mode, the first station STA1 selects the first basic service set, configured with that first security mode. The second station STA2 can thus connect to the first basic service set selected by the first station STA1.

If the second station STA2 supports several security modes, the first station STA1 selects a second the basic service set, configured with a second security mode having a higher level of security than the first security mode. For example, the first station STA1 selects the second basic service set having the highest level of security.

The first station STA1 can then transmit to the second station STA2 a routing request to the second selected basic service set, if it detects that the second security mode offers better protection than the first security mode (for example the second security mode is more recent than the first security mode). The first station STA1 can thus decide to route the second station STA2 to a basic service set taking into account the capabilities of the second station STA2.

In other words, the first station STA1 according to this embodiment proposes a first basic service set, for example the BSS1 illustrated in FIG. 1, which can be seen as a “routing” BSS, directing the second station STA2 to a BSS adapted according to the security mode(s) supported by the second station STA2, for example the BSS2 illustrated in FIG. 1. For this to be transparent to the user of the second station STA2, the user can select the only BSS visible in an interface of the second station STA2. By this action, the second station STA2 is directed to a BSS adapted to a security mode supported by the second station STA2.

The invention can thus ensure the connection of stations that do not support the new security modes and to route stations that support a given new security mode to the “right” BSS. According to a particular embodiment, it can ensure a connection of each station to the BSS that ensures it the best supported security mode.

In particular, during the discovery of the visible networks, the user of the second station only sees the BSS1, and can connect their terminal to this BSS1. The security configuration allows all stations to be able to connect to the BSS1 without any interoperability problems.

### 5.2 Embodiments

An embodiment of the invention in a Wi-Fi network in infrastructure mode is described below. It is considered according to this example that the first station is an access point/router and the second station is a client terminal.

It is also considered that the access point belongs to at least two BSS or ESS:
a first BSS, noted BSS1, identified by the identifier SSID1, and configured with a first security mode having the lowest level of protection, for example of the WPA2 type. The BSS1 guarantees interoperability with a second station that would not be updated, for example a second station that would only support the first security mode. The BSS1 can also enable the routing of a second, more recent station to a BSS configured with a second security mode having a higher level of protection than the first security mode, for example of the WPA3 type;
a second BSS, noted BSS2, identified by the identifier SSID2, and configured with a second security mode having a higher level of protection than the first security mode, for example of the WPA3 type. BSS2 is not visible to the user of the second station.

It is noted that a station supporting one security mode also supports security modes having a lower level of security. For example, a station that supports WPA3 security mode also supports earlier versions (or versions having a lower level of security) of WPA3 security mode, and therefore WPA2 security mode.

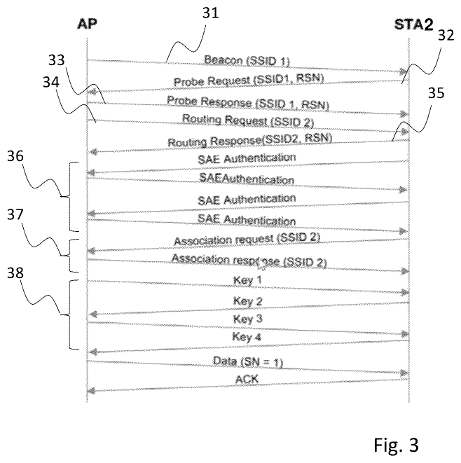

FIG. 3 illustrates an example of messages exchanged between the access point AP and the client terminal STA2 according to this embodiment.

Typically, the access point broadcasts a beacon in the Wi-Fi network, carrying information about the communication network. Such a beacon carries information enabling the characteristics of a basic service set proposed by the access point to be known, for example the identity of the access point, the frequency band (2.4 GHZ, 5 GHZ, 6 GHZ), the bandwidth (20 MHz, 40 MHz, 80 MHz, 160 MHz), etc.

According to the example illustrated in FIG. 3, the access point broadcasts a beacon 31 identifying the first basic service set BSS1, by means of the identifier SSID1.

When it tries to connect to the access point AP, the terminal STA2 sends a succession of Wi-Fi frames. The terminal STA2 can thus send the access point AP an item of information representative of the security mode(s) it supports, for example in a “Probe Request” message 32.

For example, during the sending of the “Probe Request” frame by the terminal STA2 to the access point AP in the basic service set BSS1 identified by the identifier SSID1, an “RSN Information Element” field is added to indicate the security modes supported by the terminal STA2.

The access point can respond to the “Probe Request” message 32 by sending a typical “Probe Response” message 33 of the Wi-Fi standard to the terminal STA2.

If the access point AP determines that the terminal STA2 only supports the first security mode (WPA2), then it selects the basic service set BSS1 and the terminal STA2 connects to BSS1.

If the access point AP determines that the terminal STA2 supports the second security mode (WPA3), then it redirects the terminal STA2 to the basic service set BSS2. To do this, as illustrated in FIG. 3, the access point AP transmits a routing request which proposes to the terminal STA2 to connect to the BSS2 identified by the identifier SSID2, configured with the second security mode offering a higher level of security than the first security mode (for example, the second security mode is more recent than the first security mode). For example, such a request is transmitted in the form of a new “Routing Request” frame 34. According to a particular embodiment, the “Routing Request” frame transmitted by the access point AP enables to provide the terminal STA2 with all the information needed for it to connect to the selected BSS. For example, the “Routing Request” frame carries an identifier of the selected BSS (for example a service set identifier SSID), and one or more fields typically found in the “probe response”/“association response” frames.

Upon reception of this routing request, the terminal STA2 can accept to connect to this BSS2, or decide to connect to the BSS1. It can send a response to the access point AP, for example in a “Routing Response” frame 35, carrying the identifier of the BSS to which it wishes to connect (SSID2 for example) and an “RSN Information Element” field. According to a particular embodiment, the “Routing Response” frame transmitted by the terminal STA2 enables to indicate to the access point AP whether or not it agrees to connect to the BSS selected by the AP. For example, the “Routing Response” frame carries an item of information of the “success” type if the terminal STA2 accepts to connect to the BSS selected by the AP, “failure” if not. The terminal STA2 can also indicate to the access point AP the reason(s) why it refuses to connect to the BSS selected by the access point, for example via a message of the “reason code” type taking one of the values provided by the Wi-Fi standard.

The connection continues by exchanging typical frames as described in the Wi-Fi standard, in particular during an authentication 36, association 37 and key exchange 38 procedure.

For example, the authentication procedure 36 is based on the exchange of authentication messages of the “Simultaneous Authentication of Equals (SAE)” type between the access point AP and the terminal STA2.

Once the authentication is complete, the terminal STA2 can associate 37 (register) with the access point/router to gain full access to the network. The association enables the router/access point to register each station so that the frames are delivered correctly. For example, the terminal STA2 sends the access point a request in association with the BSS2 in an “Association Request (SSID2)” message.

The access point confirms the association in an “Association Response (SSID2)” response message. The terminal STA2 is therefore routed to the BSS2 before the association procedure, enabling it to associate with the “right” BSS, for example the one configured with the highest security mode supported by the terminal STA2.

The terminal STA2 can then connect to the access point AP by the exchange 38 of keys (“Key” 1, 2, 3, 4).

### 5.3 Simplified Structures of a First Station and a Second Station

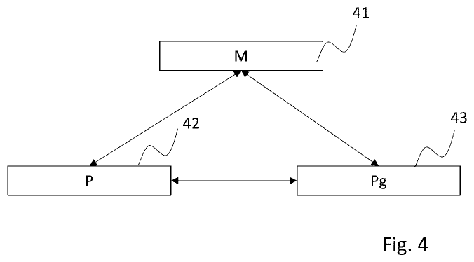

In relation to FIG. 4, the simplified structure of a first station according to at least one embodiment described above is now presented.

As illustrated in FIG. 4, such a first station comprises at least one memory 41 comprising a buffer memory, at least one processing unit 42, equipped for example with a programmable computing machine or a dedicated computing machine, for example a processor P, and controlled by the computer program 43, implementing steps of the connection method according to at least one embodiment of the invention.

At initialisation, the code instructions of the computer program 43 are for example loaded into a RAM memory before being executed by the processor of the processing unit 42.

The processor of the processing unit 42 implements steps of the connection method previously described, according to the instructions of the computer program 43, to:
receive at least one item of information representative of a security mode supported by a second station, from the second station,
select a basic service set to which the first station belongs, based on said at least one item of information representative of a security mode supported by the second station.

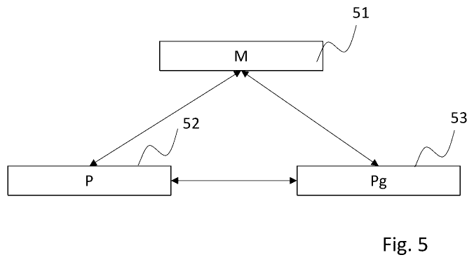

In relation to FIG. 5, the simplified structure of a second station according to at least one embodiment described above is now presented.

As illustrated in FIG. 5, such a second station comprises at least one memory 51 comprising a buffer memory, at least one processing unit 52, equipped for example with a programmable computing machine or a dedicated computing machine, for example a processor P, and controlled by the computer program 53, implementing steps of the connection method according to at least one embodiment of the invention.

At initialisation, the code instructions of the computer program 53 are for example loaded into a RAM memory before being executed by the processor of the processing unit 52.

The processor of the processing unit 52 implements steps of the connection method previously described, according to the instructions of the computer program 53, to:
transmit, to a first station, at least one item of information representative of a security mode supported by the second station,
connect to a basic service set to which the first station belongs, selected by the first station based on said at least one item of information representative of a security mode supported by the second station.

1. A method for connecting a first station to a second station in a wireless communication network, wherein said second station implements:
transmitting, to said first station, at least one item of information representative of a security mode supported by said second station; and
connecting to a basic service set to which said first station belongs, selected by said first station based on said at least one item of information representative of a security mode supported by said second station.

2. The method according to claim 1, wherein the method further comprises receiving an identifier of at least one first basic service set to which said first station belongs, said at least one first basic service set being configured with a first security mode,
and wherein said connecting comprises receiving a routing request to said selected basic service set, in response to said selected basic service set, referred to as a second basic service set, being configured with a second security mode supported by said second station and having a higher level of security than said first level of security.

3. The method according to claim 2, wherein said connection further comprises transmitting, to said first station, a response to said routing request authorising the routing to said second basic service set and the connection of said second station to said second basic service set.

4. The method according to claim 2, wherein the method comprises displaying, on said second station, said identifier of said at least one first basic service set only.

5. A method for connecting a first station to a second station in a wireless communication network, wherein said first station implements:
receiving, from said second station, of at least one item of information representative of a security mode supported by said second station; and
selecting a basic service set to which said first station belongs, based on said at least one item of information representative of a security mode supported by said second station.

6. The method according to claim 5 wherein the method also comprises:
transmitting an identifier of at least one first basic service set to which said first station belongs, said at least one first basic service set being configured with a first security mode,
transmitting a routing request to said selected basic service set, in response to said selected basic service set, referred to as a second basic service set, being configured with a second security mode supported by said second station and having a higher level of security than said first level of security.

7. The method according to claim 6, wherein the method comprises receiving, from said second station, a response to said routing request authorising routing to said second basic service set and connection of said second station to said second basic service set.

8. The method according to claim 1, wherein said at least one item of information representative of a security mode supported by said second station is transmitted in a field of the “RSN Information Element” type.

9. The method according to claim 1, wherein said at least one item of information representative of a security mode supported by said second station is transmitted in a message of the “Probe Request” type.

10. The method according to claim 1, wherein said at least one item of information representative of a security mode supported by said second station corresponds to a number of security modes supported by said second station.

11. The method according to claim 1, wherein said security modes belong to the group consisting of:
WPA2 security mode;
WPA3 security mode;
another version of the WPA security mode.

12. A non-transitory computer readable medium comprising a computer program stored thereon comprising instructions for implementing the method according to claim 1 when the program is executed by a processor of the second station.

13. A second station of a wireless communications network, comprising:
at least one processor; and
at least one non-transitory computer readable medium comprising instructions stored thereon which when executed by the at least one processor configure the second station to implement a method of connecting a first station to the second station in a wireless communication network, wherein the method comprises:
transmitting, to the first station of said network, at least one item of information representative of a security mode supported by said second station; and
connecting to a basic service set to which said first station belongs, selected by said first station based on said at least one item of information representative of a security mode supported by said second station.

14. A first station of a wireless communications network, comprising:
at least one processor; and
at least one non-transitory computer readable medium comprising instructions stored thereon which when executed by the at least one processor configure the first station to implement a method of connecting the first station to a second station in a wireless communication network, wherein the method comprises:
receiving, from the second station of said network, at least one item of information representative of a security mode supported by said second station; and
selecting a basic service set to which said first station belongs, based on said at least one item of information representative of a security mode supported by said second station.

15. The method according to claim 5, wherein said at least one item of information representative of a security mode supported by said second station is transmitted in a field of the “RSN Information Element” type.

16. The method according to claim 5, wherein said at least one item of information representative of a security mode supported by said second station is transmitted in a message of the “Probe Request” type.

17. The method according to claim 5, wherein said at least one item of information representative of a security mode supported by said second station corresponds to a number of security modes supported by said second station.

18. The method according to claim 5, wherein said security modes belong to the group consisting of:
WPA2 security mode;
WPA3 security mode;
another version of the WPA security mode.

19. A non-transitory computer readable medium comprising a computer program stored thereon comprising instructions for implementing the method according to claim 5 when the program is executed by a processor of the first station.
